(19) United States
(12) Patent Application Publication
(10) Pub. No.: US 2026/0045046 A1
(43) Pub. Date: Feb. 12, 2026

(54) SMART WORKSPACE SETUP AND GUARDIAN UX FLOW

(71) Applicant: Samsung Electronics Co., Ltd., Suwon-si (KR)

(72) Inventors: Yujie Jiang, San Jose, CA (US); Edgar Charles Evangelista, San Jose, CA (US); Ajinkya Waghulde, Castro Valley, CA (US); Hiroshi Horii, Pleasanton, CA (US)

(21) Appl. No.: 19/186,336

(22) Filed: Apr. 22, 2025

Related U.S. Application Data
(60) Provisional application No. 63/681,941, filed on Aug. 12, 2024.

(51) Int. Cl. G06T 19/00; G06F 3/01; G06F 3/04815

(52) U.S. Cl. CPC G06T 19/006; G06F 3/011; G06F 3/04815; G06T 2200/24; G06T 2210/62

(57) ABSTRACT

A method of a smart workspace setup in an extended reality (XR) environment includes detecting a user is wearing an XR headset including a display and one or more sensors. The method also includes automatically scanning an environment of the XR headset to identify boundaries of a workspace within the environment, at least one work surface within the workspace, and any obstacles within the workspace. The method also includes displaying, using three-dimensional (3D) user interface (UI) visualizations on the display of the XR headset, a virtual boundary of the workspace, a representation of the at least one work surface, and indicators for identified obstacles within the workspace. The method also includes displaying UI elements for visualizations for user modification of one or more of the virtual boundary, the representation of the at least one work surface, or the indicators for the identified obstacles.

### CROSS-REFERENCE TO RELATED APPLICATION AND PRIORITY CLAIM

This application claims priority under 35 U.S.C. § 119(e) to U.S. Provisional Patent Application No. 63/681,941 filed on Aug. 12, 2024. This provisional application is hereby incorporated by reference in its entirety.

### TECHNICAL FIELD

This disclosure relates generally to extended reality workspace setup. More specifically, this disclosure relates to improving the user experience and efficiency of extended reality workspace setup.

### BACKGROUND

Extended reality (XR) encompasses various forms of technology-enabled immersive experiences such as virtual reality (VR), augmented reality (AR), and mixed reality (MR). When setting up an XR environment as a workspace area, boundary setup is considered essential for a majority of head mounted display (HMD) headsets, whereas desk setup is often independent from boundary setup and even, in some cases, optional. When an HMD user enters a new space, the system may automatically prompt the user to initiate the boundary setup process for safety purposes. In some approaches, the boundary setup requires an open area, and any objects in the area will be considered as obstacles.

Additionally, because workspace setup is separated from boundary scanning, users may have to manually register everything from the ground up, including tables and desks, or the user may have to intentionally seek settings that enable this user flow or function. All these efforts can be daunting and extremely inconvenient for user who considers HMD to be a tool for productivity, when the HMD is used at workspace on the daily basis.

With increasing need to implement HMDs as part of a user's daily productivity routine, use cases for employing XR to work in front of a desktop are becoming more common. Most HMD experiences today are only designed for setting up in an open area, and often the desk or table is treated as an obstacle for the user to remove.

Desk setup is usually treated as optional, secondary, or an app-dependent features, and users have to manually set it up or enabling in the system menu. Typical user complaints include too many steps, frequent resetting, etc. Additionally, the option to properly set up the desk went unnoticed or was buried in the nested system settings. As a consequence, this lack of desk setup or cumbersome and inefficient process of setting up a desk leads to a steeper learning curve, builds up the barriers and time cost for users setting up their desk for work, which eventually hinders the potential for a user to comfortably use XR device as an effective tool for productivity.

### SUMMARY

This disclosure relates to smart workspace setup, including work surfaces, of an XR environment.

In a first embodiment, a method of a smart workspace setup in an extended reality (XR) environment, the method includes detecting that a user is wearing an XR headset including a display and one or more sensors with world sensing capabilities. The method also includes automatically scanning, using the one or more sensors, an environment of the XR headset to identify boundaries of a workspace within the environment, at least one work surface within the workspace, and any obstacles within the workspace. The method further includes displaying, using three-dimensional (3D) user interface (UI) visualizations on the display of the XR headset, a virtual boundary of the workspace, a representation of the at least one work surface, and indicators for identified obstacles within the workspace. The method still further includes displaying UI elements on the display of the XR headset for visualizations for user modification of one or more of the virtual boundary, the representation of the at least one work surface, or the indicators for the identified obstacles. The UI elements for the visualizations for user modification include guides for completing setup through user modification.

Any single one or any combination of the following features may be used with the first embodiment. The virtual boundary may be rendered as a semi-transparent virtual wall with animated color effects. Displaying UI elements of the visualizations for user modification of one or more of the virtual boundary, the representation of the work surface, or the indicators for the identified obstacles may include at least one of: rendering a virtual mesh corresponding to the workspace on the display of the XR headset; displaying, on the display of the XR headset, a preview of at least one pass-through cutout area for computing peripheral devices within the representation of the work surface; displaying each obstacle with visual effects covering a volume or area where the respective obstacle is positioned within the workspace; or enabling user modification of the workspace by one of extending the representation of the at least one work surface, adding to the representation of the at least one work surface, reducing the representation of the at least one work surface, subtracting from the representation of the at least on work surface, or combining two representations of work surfaces among the at least one work surface. Displaying each obstacle with visual effects covering the volume or area where the respective obstacle is positioned within the workspace may include displaying a light column covering the volume or area where the respective obstacle is positioned within the workspace, wherein a bottom portion of the light column is substantially opaque. Automatically scanning the environment of the XR headset may include recognizing horizontal or vertical surfaces in a mixed reality (MR) environment corresponding to the XR environment that satisfy criteria defined for work surfaces. Automatically scanning the environment of the XR headset may include providing visual guidance on the display of the XR headset for user movement to facilitate the scanning. Automatically scanning the environment of the XR headset may include recognizing work-related objects and obstacles on the at least one work surface.

In a second embodiment, an electronic device for smart workspace setup in an extended reality (XR) environment includes at least one processing device. The processing device is configured to detect that a user is wearing an XR headset including a display and one or more sensors with world sensing capabilities. The processing device is also configured to automatically scan, using the one or more sensors, an environment of the XR headset to identify boundaries of a workspace within the environment, at least one work surface within the workspace, and any obstacles within the workspace. The processing device is further configured to display, using three-dimensional (3D) user interface (UI) visualizations on the display of the XR headset, a virtual boundary of the workspace, a representation of the at least one work surface, and indicators for identified obstacles within the workspace. The processing device is still further configured to display UI elements on the display of the XR headset for visualizations for user modification of one or more of the virtual boundary, the representation of the at least one work surface, or the indicators for the identified obstacles, wherein the UI elements for the visualizations for user modification include guides for completing setup through user modification.

Any single one or any combination of the following features may be used with the second embodiment. The virtual boundary may be rendered as a semi-transparent virtual wall with animated color effects. Displaying UI elements of the visualizations for user modification of one or more of the virtual boundary, the representation of the work surface, or the indicators for the identified obstacles may include at least one of: rendering a virtual mesh corresponding to the workspace on the display of the XR headset; displaying, on the display of the XR headset, a preview of at least one pass-through cutout area for computing peripheral devices within the representation of the work surface; displaying each obstacle with visual effects covering a volume or area where the respective obstacle is positioned within the workspace; or enabling user modification of the workspace by one of extending the representation of the at least one work surface, adding to the representation of the at least one work surface, reducing the representation of the at least one work surface, subtracting from the representation of the at least on work surface, or combining two representations of work surfaces among the at least one work surface. Displaying each obstacle with visual effects covering the volume or area where the respective obstacle is positioned within the workspace may include displaying a light column covering the volume or area where the respective obstacle is positioned within the workspace, wherein a bottom portion of the light column is substantially opaque. Automatically scanning the environment of the XR headset may include recognizing horizontal or vertical surfaces in a mixed reality (MR) environment corresponding to the XR environment that satisfy criteria defined for work surfaces. Automatically scanning the environment of the XR headset may include providing visual guidance on the display of the XR headset for user movement to facilitate the scanning. Automatically scanning the environment of the XR headset may include recognizing work-related objects and obstacles on the at least one work surface.

In a third embodiment, a non-transitory machine readable medium for smart workspace setup in an extended reality (XR) environment includes instructions that when executed cause at least one processing device of an electronic device to detect that a user is wearing an XR headset including a display and one or more sensors with world sensing capabilities. The instructions when executed also cause at least one processing device to automatically scan, using the one or more sensors, an environment of the XR headset to identify boundaries of a workspace within the environment, at least one work surface within the workspace, and any obstacles within the workspace. The instructions when executed further cause at least one processing device to display, using three-dimensional (3D) user interface (UI) visualizations on the display of the XR headset, a virtual boundary of the workspace, a representation of the at least one work surface, and indicators for identified obstacles within the workspace. The instructions when executed still further cause at least one processing device to; and display UI elements on the display of the XR headset for visualizations for user modification of one or more of the virtual boundary, the representation of the at least one work surface, or the indicators for the identified obstacles, wherein the UI elements for the visualizations for user modification include guides for completing setup through user modification.

Any single one or any combination of the following features may be used with the third embodiment. The virtual boundary may be rendered as a semi-transparent virtual wall with animated color effects. Displaying UI elements of the visualizations for user modification of one or more of the virtual boundary, the representation of the work surface, or the indicators for the identified obstacles may include at least one of: rendering a virtual mesh corresponding to the workspace on the display of the XR headset; displaying, on the display of the XR headset, a preview of at least one pass-through cutout area for computing peripheral devices within the representation of the work surface; displaying each obstacle with visual effects covering a volume or area where the respective obstacle is positioned within the workspace; or enabling user modification of the workspace by one of extending the representation of the at least one work surface, adding to the representation of the at least one work surface, reducing the representation of the at least one work surface, subtracting from the representation of the at least on work surface, or combining two representations of work surfaces among the at least one work surface. Displaying each obstacle with visual effects covering the volume or area where the respective obstacle is positioned within the workspace may include displaying a light column covering the volume or area where the respective obstacle is positioned within the workspace, wherein a bottom portion of the light column is substantially opaque. Automatically scanning the environment of the XR headset may include recognizing horizontal or vertical surfaces in a mixed reality (MR) environment corresponding to the XR environment that satisfy criteria defined for work surfaces. Automatically scanning the environment of the XR headset may include providing visual guidance on the display of the XR headset for user movement to facilitate the scanning. Automatically scanning the environment of the XR headset may include recognizing work-related objects and obstacles on the at least one work surface.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLETV), a smart speaker or speaker with an integrated digital assistant (such as SAMSUNG GALAXY HOME, APPLE HOMEPOD, or AMAZON ECHO), a gaming console (such as an XBOX, PLAY STATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include new electronic devices depending on the development of technology.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112(f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112(f).

### BRIEF DESCRIPTION OF THE DRAWINGS

For a more complete understanding of this disclosure and its advantages, reference is now made to the following description taken in conjunction with the accompanying drawings, in which like reference numerals represent like parts:

FIG. 1 illustrates an example network configuration that may be employed for smart XR workspace setup in accordance with this disclosure;

FIG. 2 illustrates an example process of smart XR workspace setup in accordance with this disclosure;

FIG. 3 is a diagram illustrating a system for smart XR workspace setup using world sensing technology in accordance with this disclosure;

FIG. 4 is a diagram illustrating in greater detail the architecture for smart XR workspace setup entry points in accordance with this disclosure;

FIG. 5 graphically illustrates one example of a stationary workspace boundary setup in accordance with FIG. 3;

FIGS. 6A and 6B illustrate plane detection during stationary workspace boundary setup in accordance with FIG. 3;

FIG. 7 is a diagram illustrating an example of workspace plane determination during stationary workspace boundary setup in accordance with this disclosure;

FIG. 8 graphically illustrates one example of automatic scanning for smart workspace setup in accordance with FIG. 3;

FIGS. 9A and 9B illustrate various examples of UI visual effects to guide the user in initiating or progressing through automatic scanning for smart workspace setup in accordance with FIG. 3;

FIGS. 10 and 10A graphically illustrates one example of smart rendering and preview of the workspace setup in accordance with FIG. 3;

FIGS. 11A and 11B illustrate examples of smart rendering based on obstacle recognition during rendering and preview of the workspace setup in accordance with FIG. 3;

FIG. 12 illustrates an example of different fidelities for smart rendering based on object recognition of work-related objects during rendering and preview of the workspace setup in accordance with FIG. 3;

FIGS. 13A and 13B collectively illustrate an example of occlusion effects for smart rendering based on recognition of either work-related objects or obstacles during rendering and preview of the workspace setup in accordance with FIG. 3;

FIGS. 14, 14A, and 14B illustrate an exemplary environment for post-setup interactions in accordance with FIG. 3;

FIGS. 15 and 15A-15D depict possible variations of post-setup interactions in VR in accordance with FIG. 3;

FIGS. 16A-16C depict possible variations of post-setup interactions in AR/MR in accordance with FIG. 3;

FIGS. 17A and 17B depict possible variations of post-setup interactions in AR/MR in accordance with FIG. 3;

FIG. 18 is a diagram illustrating a UX system for multimodal workspace setup in accordance with this disclosure;

FIGS. 19A and 19B illustrate enlarging or reducing the workspace area as part of post-setup interactions in AR/MR in accordance with FIG. 3;

FIGS. 20A and 20B illustrate adding editing points to redefine the shape of a work surface as part of post-setup interactions in AR/MR in accordance with FIG. 3;

FIG. 21 illustrates adding or removing obstacles outside of the workspace area as part of post-setup interactions in AR/MR in accordance with FIG. 3;

FIG. 22 illustrates manually assigning or unassigning items as work-related objects in the workspace area as part of post-setup interactions in AR/MR in accordance with FIG. 3;

FIG. 23 illustrates subtracting area from a workspace area as part of post-setup interactions in AR/MR in accordance with FIG. 3;

FIG. 24 illustrates presenting a preview 3D map as part of post-setup interactions in AR/MR in accordance with FIG. 3;

FIG. 25 illustrates displaying a mini preview as part of post-setup interactions in AR/MR in accordance with FIG. 3;

FIGS. 26A through 26E illustrate an example of manual desk setup as part of multimodal/manual workspace setup in accordance with FIG. 18;

FIGS. 27A through 27C illustrate remote tracing as part of multimodal/manual workspace setup in accordance with FIG. 18;

FIGS. 28A through 28C illustrate palm swiping as part of multimodal/manual workspace setup in accordance with FIG. 18;

FIGS. 29A through 29C illustrate diagonal mapping as part of multimodal/manual workspace setup in accordance with FIG. 18;

FIGS. 30A and 30B illustrate defining multiple work surface areas as part of multimodal/manual workspace setup in accordance with FIG. 18;

FIGS. 31A and 31B illustrate defining multiple workspace areas as part of multimodal/manual workspace setup in accordance with FIG. 18;

FIG. 32 illustrates rendering of a stationary workspace boundary during smart rendering and preview of the workspace setup in accordance with FIG. 3;

FIG. 33 illustrates rendering during smart rendering and preview of the workspace setup in accordance with FIG. 3;

FIGS. 34A through 34D and FIGS. 35A through 35E illustrate rendering for obstacle warnings during smart rendering and preview of the workspace setup in accordance with FIG. 3;

FIGS. 36A through 36D illustrate rendering for boundary modification during post-setup interactions in accordance with FIG. 3;

FIGS. 37A, 37B, 38A, 38B, 39A, 39B, 40A, and 40B illustrate examples of visualization effects for boundary modification during post-setup interactions in accordance with FIG. 3; and

FIG. 41 illustrates rendering for post-setup wall effects during post-setup interactions in accordance with FIG. 3.

### DETAILED DESCRIPTION

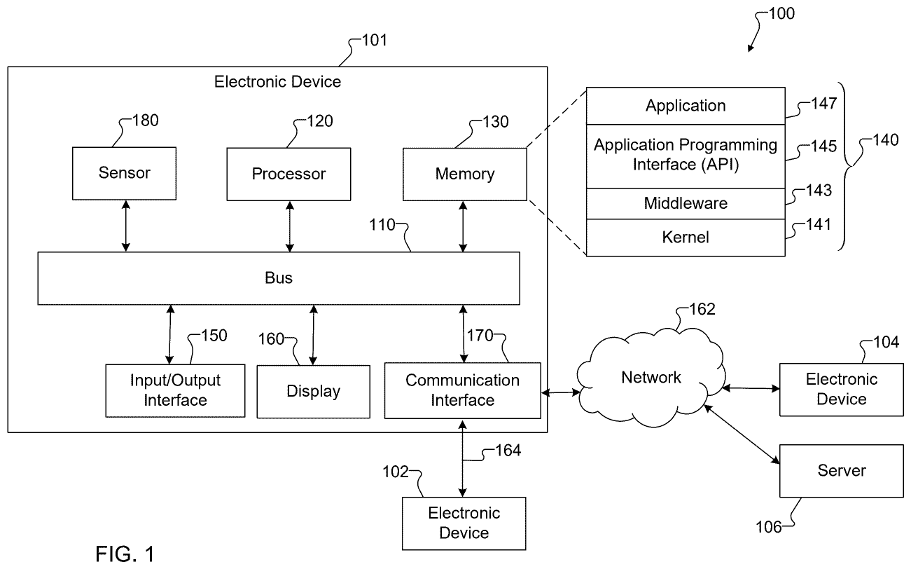

FIGS. 1 through 41, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

The demand for conveniently setting up virtual counterparts to physical desktops intuitively and conveniently for better productivity in XR needs to be fulfilled. The present disclosure addresses the above-described challenges and offers a more intuitive, user-friendly, automatic, and flexible system for setting up a user's desk workspace. The solution described herein may be adapted to various XR space setup processes and use cases, enhancing the overall interaction and user workspace experience in the XR environment and adapted to advanced room scanning and object recognition technology.

The present disclosure utilizes world sensing technology to help users make the workspace setup in a smarter way with minimum steps, shortening setup flow. The present disclosure also unlocks the possibility to integrate the workspace setup with the boundary system setup for HMD users within the XR environment.

Automatic room scanning may be combined with world-sensing technology to smartly set up a workspace (desk and table) in XR. World sensing delivers an accurate understanding of the people and things around users wearing HMD, so that users can maintain a consistent experience between real and virtual worlds. The technology used under the world sensing technology umbrella includes plane detection, object recognition, computer vision, etc. Diverse visualization effects may be included that may be used/applied during the workspace setup process so that users are benefit from having a more enriched experience in setting up the workspace.

Multimodal interactions may be included to setup up a workspace with more efficient interactive touch points, using pinch and gaze.

Various specialized rendering techniques and principles guide users through room scanning, previewing, avoiding obstacles, and setting up the workspace with a more informative and enriched user experience (UX).

In the context of XR, the shortened and automated workspace setup procedure can significantly enhance a user's productivity. The process includes integrated automatic room scanning technology with more efficient interaction touch points. Users can also benefit from the recommended user flow and guided visual effects that enrich the user experience.

FIG. 1 illustrates an example network configuration 100 that may be employed for smart XR workspace setup in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, or a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), or a graphics processor unit (GPU). The processor 120 is able to perform control on at least one of the other components of the electronic device 101 and/or perform an operation or data processing relating to communication or other functions. As described in more detail below, the processor 120 may perform various operations related to smart XR workspace setup.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may support various functions related to smart XR workspace setup. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, one or more sensors 180 can include one or more cameras or other imaging sensors for capturing images of scenes. The sensor(s) 180 can also include one or more buttons for touch input, one or more microphones, a gesture sensor, a gyroscope or gyro sensor, an air pressure sensor, a magnetic sensor or magnetometer, an acceleration sensor or accelerometer, a grip sensor, a proximity sensor, a color sensor (such as an RGB sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. The sensor(s) 180 can further include an inertial measurement unit, which can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the first external electronic device 102 or the second external electronic device 104 can be a wearable device or an electronic device-mountable wearable device (such as a head mounted display (or “HMD”)). When the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network. The electronic device 101 can also be an augmented reality wearable device, such as eyeglasses, which include one or more imaging sensors, or a VR or XR headset.

The first and second external electronic devices 102 and 104 and the server 106 each can be a device of the same or a different type from the electronic device 101. According to certain embodiments of this disclosure, the server 106 includes a group of one or more servers. A Iso, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components 110-180 as the electronic device 101 (or a suitable subset thereof). The server 106 can support the electronic device 101 by performing at least one of the operations (or functions) implemented on the electronic device 101. For example, the server 106 can include a processing module or processor that may support the processor 120 implemented in the electronic device 101. As described in more detail below, the server 106 may perform various operations related to smart XR workspace setup.

Although FIG. 1 illustrates one example of a network configuration 100 including an electronic device 101 employed for smart XR workspace setup, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

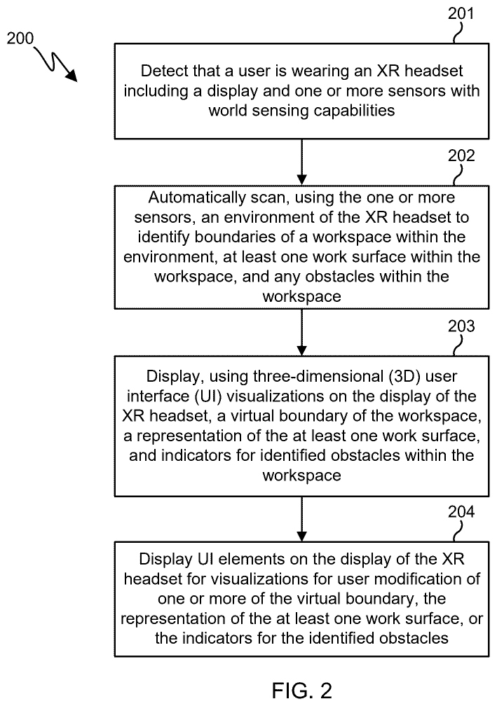

FIG. 2 illustrates an example process 200 of smart XR workspace setup in accordance with this disclosure. For ease of explanation, the process 200 of FIG. 2 is described as being performed using the electronic device 101 in the network configuration 100 of FIG. 1. However, the process 200 may be performed using any other suitable device(s) and in any other suitable system(s).

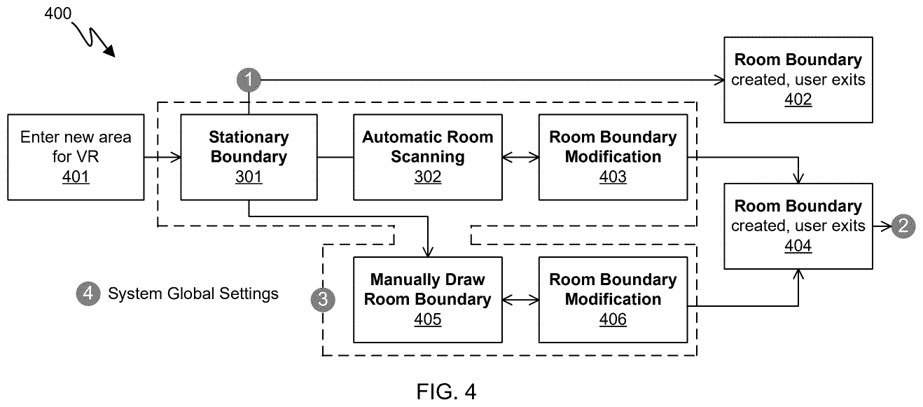

As shown in FIG. 2, the process 200 begins with detecting that a user is wearing an XR headset including a display and one or more sensors with world sensing capabilities (step 201). As discussed in further detail below in connection with FIG. 4, one of four potential entry points may be used to enter the smart XR workspace setup process 200. Using the one or more sensors, an environment of the XR headset is automatically scanned to identify boundaries of a workspace within the environment, at least one work surface within the workspace, and any obstacles within the workspace (step 202). The workspace boundaries correspond to walls and furnishings. The work surface(s) may be horizontal (e.g., a table or desk) or vertical (free wall space suitable for use as a virtual workspace). Using three-dimensional (3D) user interface (UI) visualizations on the display of the XR headset, a virtual boundary of the workspace, a representation of the at least one work surface, and indicators for identified obstacles within the workspace are displayed (step 203). Various forms for indicating workspace boundaries and obstacles are described in greater detail below. Obstacles on work surfaces are also indicated. UI elements are displayed on the display of the XR headset for visualizations for user modification of one or more of the virtual boundary, the representation of the at least one work surface, or the indicators for the identified obstacles (step 204). The UI elements for the visualizations for user modification include guides for completing setup through user modification.

Although FIG. 2 illustrates one example of a process 200 of smart XR workspace setup, various changes may be made to FIG. 2. For example, while shown as a series of steps, various steps in FIG. 2 could overlap, occur in parallel, occur in a different order, or occur any number of times (including zero times).

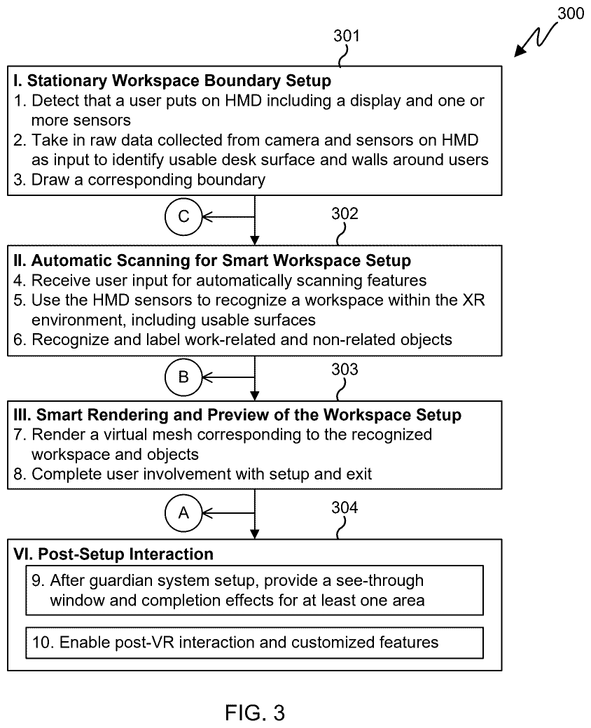

FIG. 3 is a diagram illustrating a system 300 for smart XR workspace setup using world sensing technology in accordance with this disclosure. For ease of explanation, the automation system 300 of FIG. 3 is described as being implemented within the server 106 in the network configuration 100 of FIG. 1, and interacting with (for example) the electronic device 101 and/or the external electronic device 102 to set up an XR workspace for the electronic device 101. However, the automation system 300 may be implemented using any other suitable device(s) and in any other suitable system(s).

Among the important aspects of any XR experience is the alignment of the real and digital worlds. World sensing technology provides an understanding of the real world environment and things around the XR headset user, including scene understanding (plane detection and alignment, depth/occlusion, object placement, lighting, etc.), object detection and tracking, boundary, and persistence. Typical HMD Sensors used for world sensing include (but are not limited to:
Image sensors (e.g., red-green-blue (RGB) cameras that capture images of objects and planes in the environment, which can then be processed using computer vision techniques to detect and analyze for workspace setup;
Depth-sensing cameras to gain depth information of object in the environment;
Infrared (IR) sensors to track positions of objects and people within the VR environment;
light detection and ranging (LIDAR) device, which use laser light to measure distances and create 3D maps of the environment;
ultrasonic/proximity sensors, which to emit sounds waves and measure the reflection to detect objects in distance; and
accelerometers and gyroscopes to track motion and orientation of the user's position relative to the wall and tables.

Different HMDs may implement different sets of sensors providing different capabilities in collecting raw data, with different data quality, for smart workspace setup. Thus, the outcome accuracy and necessary UX flow may be vary based on HMD architecture. With improvement on HMDs, however, more capabilities or data accuracy may be added.

The present disclosure aims to automate the workspace setup as much as possible utilizing automatic room scanning and world sensing technology. The automation system 300 includes four main UX flows:
I. Stationary workspace boundary setup 301, which includes at least:
   1. Detecting that a user puts on HMD including a display and one or more sensors.
   2. Taking in raw data collected from camera and sensors on HMD as input to identify usable desk surface and walls around users.
   3. Drawing a corresponding boundary.
II. Automatic scanning for smart workspace setup 302, which includes at least:
   4. Receive user input for automatically scanning features.
   5. Use the HMD sensors to recognize a workspace within the XR environment, including usable surfaces.
   6. Recognize and label work-related and non-related objects.
III. Smart rendering and preview of the workspace setup 303, which includes at least:
   7. Render a virtual mesh corresponding to the recognized workspace and objects.
   8. Complete user involvement with setup and exit.
IV. Post-setup interactions 304, which includes at least:
   9. After guardian system setup, provide a see-through window and completion effects for at least one area.
   10. Enable post-VR interaction and customized features.

The two post-setup interactions 304 may be entirely independent, such that either may be performed in any order or without the other.

Although FIG. 3 illustrates one example of an automation system 300, various changes may be made to FIG. 3. For example, while shown as discrete functions operating serially, various functions in FIG. 3 could be combined or separated, or arranged to operate in a different order or to operate in parallel.

FIG. 4 is a diagram illustrating in greater detail the architecture 400 for smart XR workspace setup entry points in accordance with this disclosure. For ease of explanation, the architecture 400 of FIG. 4 is described as being implemented within the server 106 in the network configuration 100 of FIG. 1, and interacting with (for example) the electronic device 101 and/or the external electronic device 102 to set up an XR workspace for the electronic device 101. However, the architecture 400 may be implemented using any other suitable device(s) and in any other suitable system(s).

In the architecture 400 of FIG. 4, o into the traditional boundary setup flow. When a user wearing an HMD enters a new area for XR 401, stationary workspace boundary setup 301 may be initiated. Once the room boundary is created and the user exits 402, operation of the stationary workspace boundary setup 301 may end. In either case, these components represent a first entry point (“ [symbol] ”), by which workspace setup is initiated automatically while user is scanning the room and at least one usable surface is detected during boundary setup. Thus, any desk area and wall that the user scans are included as part of the consideration for forming boundaries.

Alternatively, after stationary workspace boundary setup 301, automatic scanning for smart workspace setup 302 may initiate to perform room boundary modification 403. Again, once the room boundary is created and the user exits 404, operation of the automatic scanning for smart workspace setup 302 may end. The latter component represents a second entry point (“ [symbol] ”), by which the user is prompted to continue to workspace setup after the boundary setup.

Another alternative, after stationary workspace boundary setup 301, is that manually drawing room boundaries 405 may initiate, to perform room boundary modification 406. Yet again, once the room boundary is created and the user exits 404, operation of manually drawing room boundaries 405 may end. Manual boundary drawing represents a third entry point (“ [symbol] ”), which the user can manually set up workspace boundary while manually setting up the floor boundary. Finally, the user can enable workspace setup separately in the system global settings, representing a fourth entry point (“ [symbol] ”).

Although FIG. 4 illustrates one example of an architecture 400, various changes may be made to FIG. 4. For example, while shown as discrete components operating collaboratively, various components in FIG. 4 could be combined or separated, or arranged a differently relative to the entry points indicated.

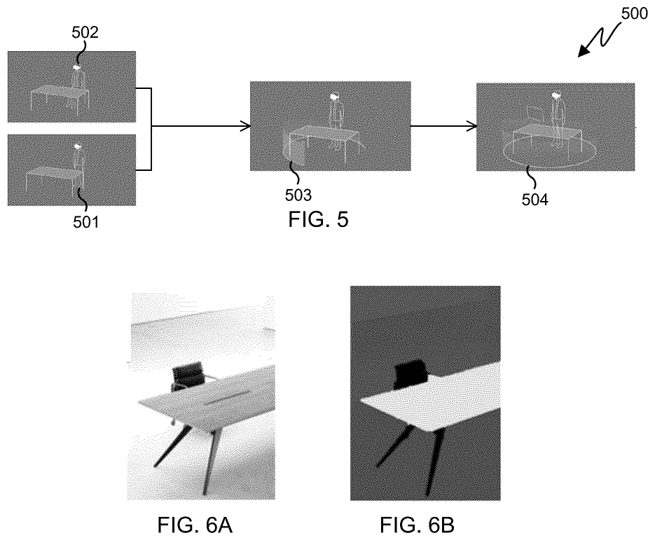

FIG. 5 graphically illustrates one example 500 of stationary workspace boundary setup 301 in accordance with FIG. 3. When the HMD is put on, the system takes in raw data collected from cameras and sensors as input to identify usable desk surface and walls around users. By detecting at least one usable surface, a workspace setup will be initiated. Then, a corresponding stationary workspace boundary can be drawn accordingly. As shown in FIG. 5, the user may begin use of an HMD headset within a new physical area for VR, in any of the standing posture 501, the sitting posture 502, or both. The camera and depth sensors in the HMD examine the user's environment (i.e., with respect to floor level) to determine whether there exists any elevated horizontal surface such as a table or desk. As the user looks around while wearing the HMD, the system automatically detects the floor, wall(s), and any planar surface areas around the user. A default stationary workspace boundary within the augmented reality/mixed reality (AR/MR) environment is drawn around the user in a video see-through (VST) mode. Upon completion of the stationary workspace boundary 504, a visualization effect is rendered (as described in further detail below in connection with visual effects). The user may be provided with the option to exit at this stage, or to continue.

FIGS. 6A and 6B illustrate plane detection during stationary workspace boundary setup 301 in accordance with FIG. 3. Plane detection recognizes real-world surfaces. By accessing the camera data and sensors of the HMD, the system identifies different types of planes, such as horizontal and vertical surfaces. FIGS. 6A and 6B respectively depict the camera input for a table and chair and the associated horizontal plane detected by the system. Horizontal or vertical surfaces are identified (based on depth data) as possible workspaces (e.g., based on area), and those horizontal and vertical surfaces are identified by the system as potential workspaces. By defining/setting a preferred distance plus height for workspace surfaces (e.g., a default height and distance values that may be set, or a range that varies based on user preferences), the system can decide the usable surface within a preferred workspace area. Then, a stationary boundary is generated and encompasses around the detected usable surfaces.

To determine whether the plane is usable as a workspace surface (i.e., desk/table), depth data determined with depth sensors on the HMD are mapped to scanned regions within the XR environment, and the parts of the environment with which the user can interact may then be determined (e.g., eliminating surfaces that are too high, too low, too small, too far, etc., for a user to work on).

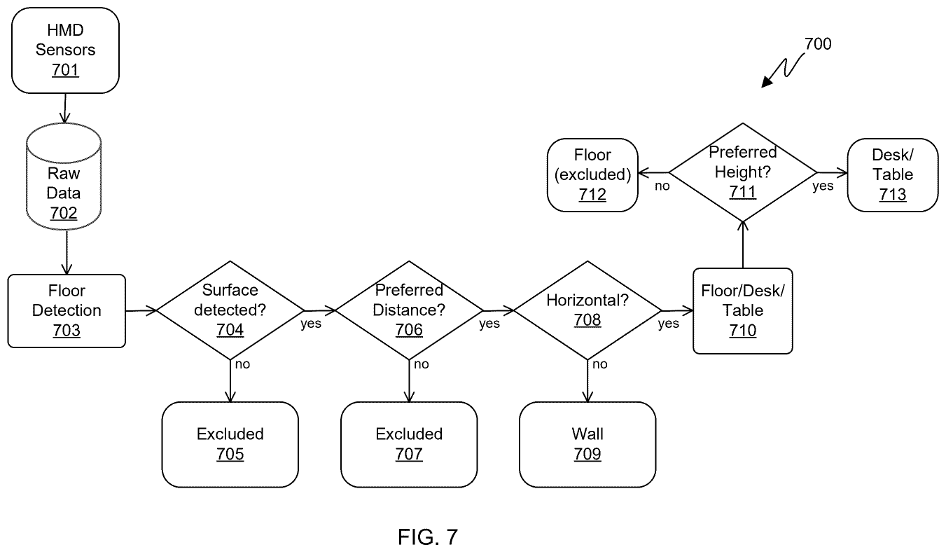

FIG. 7 is a diagram illustrating an example of workspace plane determination 700 during stationary workspace boundary setup in accordance with this disclosure. For ease of explanation, the workspace plane determination 700 of FIG. 7 is described as being implemented within the server 106 in the network configuration 100 of FIG. 1, and interacting with (for example) the electronic device 101 and/or the external electronic device 102 to setup an XR workspace for the electronic device 101. However, the workspace plane determination 700 may be implemented using any other suitable device(s) and in any other suitable system(s).

In the workspace plane determination 700, HMD sensors 701 (e.g., sensor(s) 180) collect raw data 702 that is employed first to evaluate the elevation of objects within the field of view, for floor detection 703. The same raw data 702 is also evaluated for planar surfaces. For example, object surfaces may be evaluated primarily for planarity, and secondarily for a threshold size of the planar portion(s). Both determinations may be adapted to accommodate objects that appear to rest on the planar surface, discussed in further detail below. When a surface is detected 704 but does not meet specified criteria, the surface is excluded 705 as a possible workspace. A detected surface that does meet the defined criteria (e.g., planarity, size, etc.) may be referred to herein as a “qualified” detected surface.

When a surface is detected 704 that does meet defined criteria (e.g., planarity, size, etc.), a determination 706 is made of whether the qualified detected surface is located within a preferred distance from the HMD being worn by the user (i.e., HDM≤x meters (m)). As apparent, this portion of the example the workspace plane determination 700 should be repeated as the user moves about a space, to detect multiple potential workspaces. If not located within the preferred distance, the qualified detected surface is excluded 707 as a possible workspace. Upon user movement within the area, however, the same qualified detected surface may be recategorized as a possible workspace, as user movement causes that same surface to lie within the preferred distance.

If a qualified detected surface is situated within the preferred distance from the HMD, a determination 708 is made as to whether the qualified detected surface is horizontal. Accelerometers and image projection within the HDM may be employed to determine if the qualified detected space is substantially horizontal (or, alternatively or additionally, substantially vertical). If not substantially horizontal (and particularly if also determined to be substantially vertical), the qualified detected surface is identified 709 as a possible wall. Notably, the qualified detected surface is not excluded as a possible workspace, merely identified as likely being of a certain type of workspace (i.e., a wall). If, on the other hand, the qualified detected surface is determined to be substantially horizontal, the qualified detected surface is identified 710 as (likely) one of the floor, a desk, or a table.

For qualified detected surfaces that are both horizontal and within the preferred distance, a determination 711 is made as to whether the qualified detected (horizontal) surface is situated at a preferred height (i.e., either HDM≥y1 m. HDM≤y2 m, or y1 m≤HMD≤y2 m). If not, the qualified detected (horizontal) surface is identified 712 as likely being the floor (effectively excluded as a possible workspace). If so, however, the qualified detected (horizontal) surface is identified 713 as likely being a desk or a table, and therefore a possible workspace.

Although FIG. 7 illustrates one example of a workspace plane determination 700, various changes may be made to FIG. 7. For example, while some of the determinations are shown as discrete determinations, various decisions in FIG. 7 could be combined, or occur in a different order from that indicated.

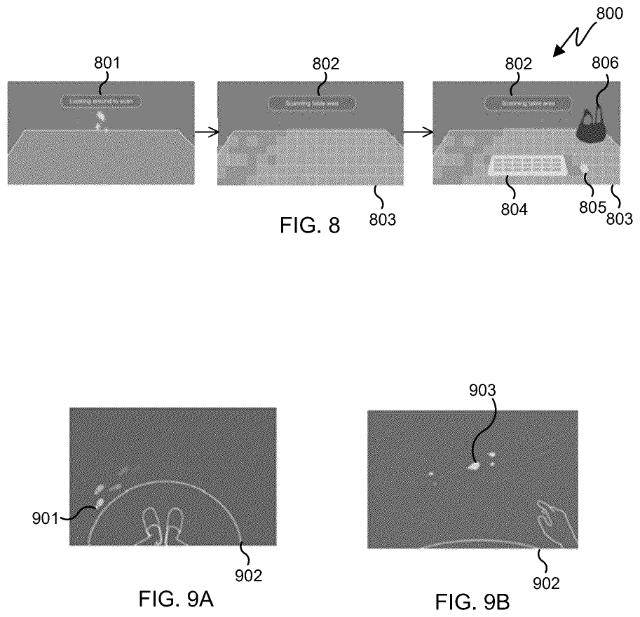

FIG. 8 graphically illustrates one example 800 of automatic scanning for smart workspace setup 302 in accordance with FIG. 3. Automatically scanning environmental features can be initiated upon user input (e.g., user's movement for following animated UI guide and looking around). A workspace that includes at least one usable surface can be scanned, and workspace objects on the usable surface can be recognized within the XR environment.

To initiate the room scanning process, an animated UI 801 guides the user's attention to look around, to initiate automatic room scanning. While the user is looking around, the HMD (including a display and one or more sensors recognize a work surface within the MR, and the scan is virtually rendered on the work surface. For any obstacles on the work surface, if the scan is not complete, then a UI 802 and a fragmented mesh 803 is presented to encourage the user to look at the work surface again in order to improve the quality of the scan.

While scanning the work surface, objects (such as a keyboard 804, a mouse 805, and a bag 806 in the example depicted) are recognized and labeled by computer vision. Unrecognized or unlabeled objections are treated as obstacles with visual cures, for the user to be aware of the object's existence. A UI toast is also provided to remind the user to remove obstacles and keep the work surface clean.

FIGS. 9A and 9B illustrate various examples of UI visual effects (following visual effect principles described in further detail below), to guide the user in initiating or progressing through automatic scanning for smart workspace setup 302 in accordance with FIG. 3. Automatic room scanning tracks the user's head and eye movements. Accordingly, without the user looking around, the scanning often fails to launch, or fails in some other respect. To reduce the risk of automatic room scanning failure, having an intuitive animated UI to guide the user's attentions is important in the scanning process. FIG. 9A illustrates using footsteps 901 on the floor as an indicator to encourage the user to move around the workspace. A scan boundary 902 may also be displayed. FIG. 9B illustrates using highlighting 903 to indicate objects for which further scanning is needed. The highlighting is intended to encourage the user to focus on the object(s), move closer to the objects, or both.

As part of workspace and object recognition through automatic room scanning, raw data are collected from cameras and sensors on the HMD, then the scanned data can be used for:
Image processing: While camera sensors scan and capture the space that user occupies, computer vision analyzes the scanning results, looking for patterns, traits, texture, and other key details identify the objects.
Depth mapping: With depth sensors on the HMD, the depth data are mapped to scanned objects within the XR environment. Thus, the objects in the environment with which the user can interact can be determined (e.g., whether objects that are work related, too far from the workspace, etc.).
As the output, the work surface (e.g., a desk top) and work-related objects (e.g., mouse 805, keyboard 804, etc.) and non-work-related objects (e.g., decorations) are recognized and categorized. Objects unrelated to work are rendered as obstacles.

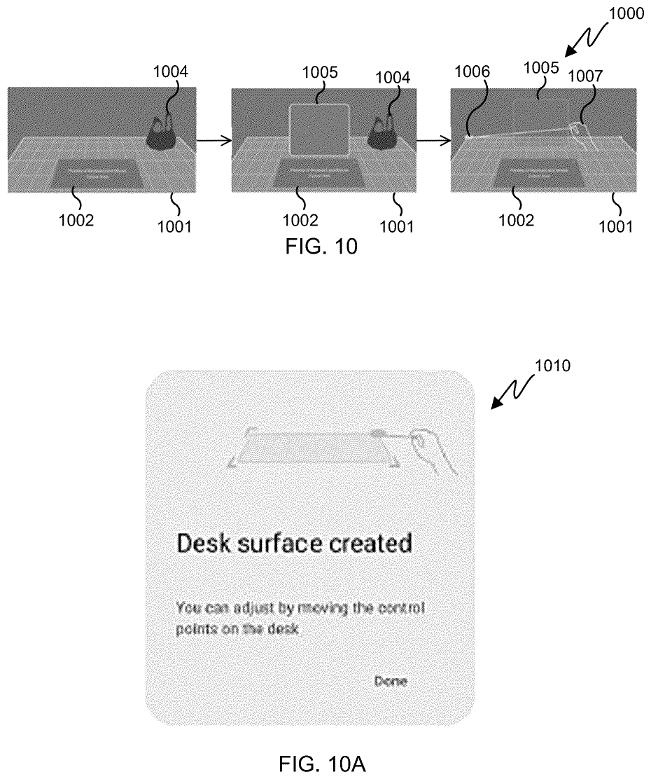

FIGS. 10 and 10A graphically illustrates one example 1000 of smart rendering and preview of the workspace setup 303 in accordance with FIG. 3. Rendering and preview the workspace setup includes rendering a virtual mesh 1001 corresponding to the recognized work surface and objects thereon. Upon completion of scanning, the user sees the preview of the workspace with a rendered keyboard and mouse area 1002, which later turns into a passthrough window to show the actual keyboard and mouse after the desk setup is complete. Obstacles 1003 are rendered in warning colors (e.g., red outlined black shapes). When the preview is rendered, the user may be prompted 1004 to finish the setup or instructed to continue modifying the setup. An example 1010 of prompt 1004 that may be displayed is shown in FIG. 10A.

To continue with modifying setup of the rendered preview for the work surface, the user may pinch to grab the corner 1006 of desk/table within the rendered preview and drag 1007 (e.g., push outward or pull inward) to redefine the size. Details of more modification methods are described below.

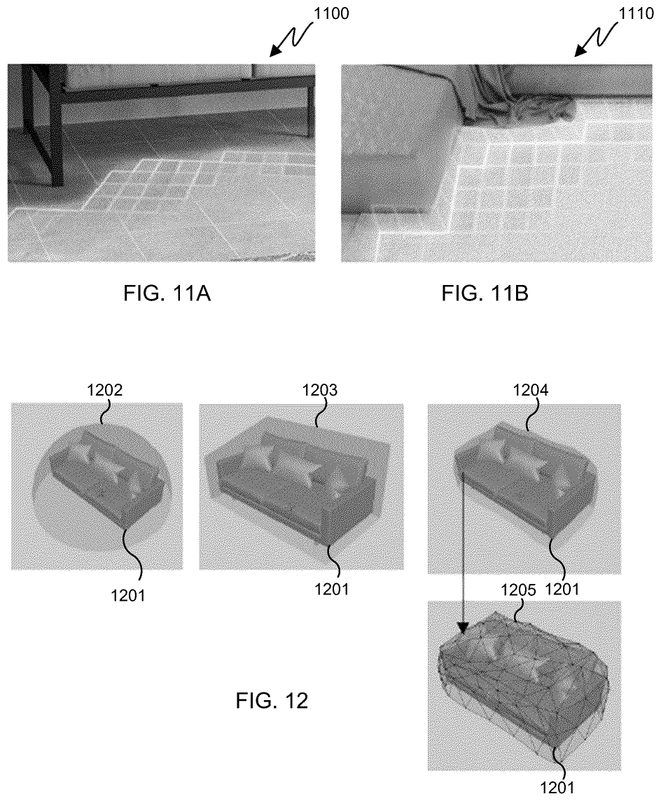

FIGS. 11A and 11A illustrate examples 1100, 1110 of smart rendering based on obstacle recognition during rendering and preview of the workspace setup 303 in accordance with FIG. 3. Any surface or object that is recognized as not work-related is rendered as an obstacle. When encountering obstacles, the mesh is rendered in real-time and adjusted to accommodate the obstacle(s), so that users are aware of the obstacle's existence and locations in the workspace. Obstacles are rendered explicitly, with passthrough view and wrapped and/or buffered mesh. When the scanning mesh encounters an obstacle, the system can decide how the mesh wraps around the obstacle, and with buffer distance, based on the sharpness and texture of the obstacle. FIG. 11A illustrates an example 1100 for a more “dangerous” obstacle—that is, an object with harsh or fragile material such as glass, or with sharper edges or corners, for which the mesh stops short and gives more buffer space around the obstacle. FIG. 11B illustrates an example 1110 for a “safer” obstacle, with softer material or less sharp (or fewer) edges, for which the buffer distance may be very small or even negative (i.e., climbing up on the obstacle as shown in FIG. 11B). The more rounded and softer objects, the less buffer distance. This provides more visual awareness of the obstacle while providing the user with a closer look at the obstacle without need for a trigger warning when breaking a boundary. The two examples of obstacle rendering in FIGS. 11A and 11B follow the visual effect principles discussed below.

FIG. 12 illustrates an example 1200 of different fidelities for smart rendering based on object recognition of work-related objects during rendering and preview of the workspace setup 303 in accordance with FIG. 3. A passthrough cutout will be generated within the XR view according to the shape of the work-related object 1201, so that the user can easily access to the object when the user acts within the VR environment. The passthrough cutout may have different shapes/fidelities to the work-related object, generated based on the mesh mapped on to the work-related object. A dome shape cutout 1202 has the lowest fidelity for most (i.e., non-hemispherical) work-related objects. A 3D trapezoid cutout 1203 may more closely approximate the actual shape of the work-related object 1201. A mesh-mapped cutout 1204, for the mesh 1205 having nodes and surfaces with defined distance(s) from surfaces of the work-related object, will produce the highest fidelity to the work-related object shape.

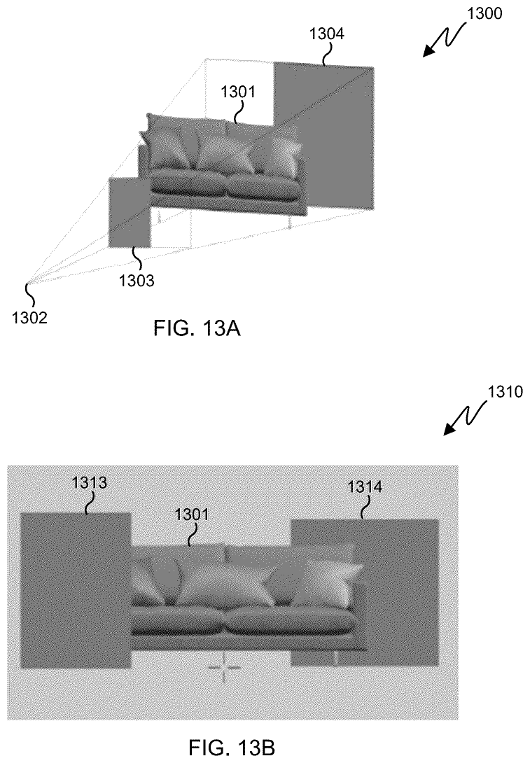

FIGS. 13A and 13B collectively illustrate an example 1300, 1310 of occlusion effects for smart rendering based on recognition of either work-related objects or obstacles during rendering and preview of the workspace setup 303 in accordance with FIG. 3. Occlusion effects are possible with depth sensor capability, so that any surface or object is mapped with depth information in the workspace area. As shown in FIG. 13A, the detected object 1301 may have perspective point 1302 from the camera, from which depth sensors can identify near plane 1303 and a far plane 1304 relative to the object. The recognized object is partially rendered based on such depth information to create occlusion effects. Any other objects or spaces that are detected and understood as either closer 1313, occluding a portion of object 1301, or further or behind 1314 the recognized object 1301 and are at least partially occluded.

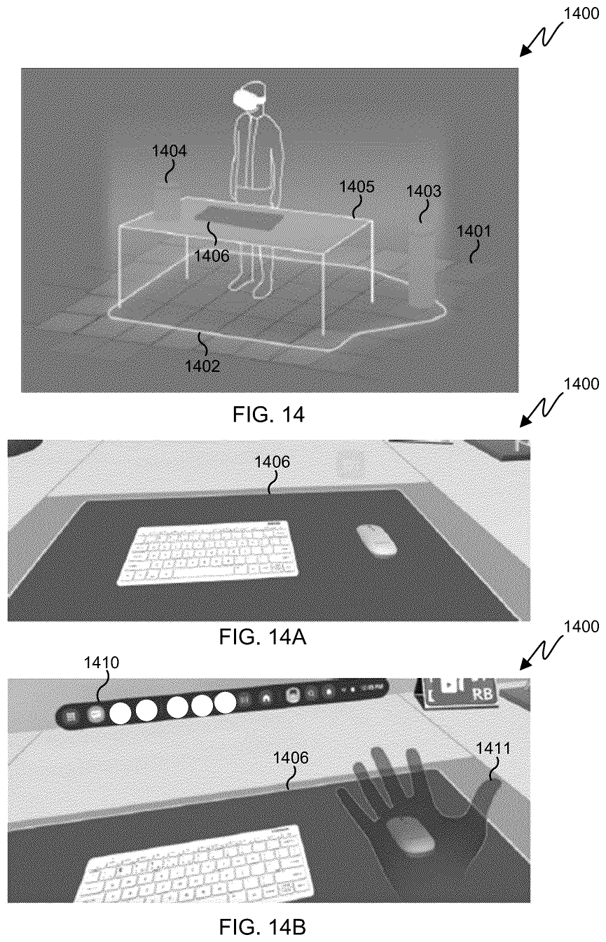

FIGS. 14 and 14A-14B illustrate an exemplary environment 1400 for post-setup interactions 304 in accordance with FIG. 3. FIG. 14 illustrates the environment 1400 from a perspective outside the environment 1400, while FIGS. 14A and 14B illustrate a user's view of portions of the environment 1400.

Upon completing set-up of a workspace, a virtual mesh 1401 corresponding to the recognized workspace is rendered to indicate the space. The effect will last for a predetermined duration (e.g., 5 seconds (s)) and then fade out. During the period in which the virtual mesh 1401 is displayed, the user either enters a VR environment or stays in an AR/MR environment. After the virtual mesh 1401 fades, boundary 1402 visualization effects may subsequently re-appear when the user starts to move beyond the defined workspace area or approaches the obstacles 1403, 1404.

If user enters VR rather than remaining in the AR/MR environment, a passthrough cutout is rendered on the work surface 1405 for work-related objects. In the example shown in FIGS. 14 and 14A-14B, the user sees a cutout area 1406 generated for keyboard and mouse (and optionally also a phone, etc.), so that the user can interact those productivity tools in real world at the same time.

The rendered workspace is world-anchored, which user can walk around and view the space from different perspectives. Digital contents such as a toolbar 1410 and/or a cursor 1511 (hand-shaped in the example illustrated) can also be displayed for the user. Such digital contents may circumvent the obstacles 1403, 1404 in the workspace, but the user can manually remove or unregister an obstacle.

During post-setup interactions 304 in VR and upon completion of workspace setup, when the user leaves or is about to leave the defined workspace, the system provides visual feedback if user is about to step out of the boundary 1402. As the user approaches the boundary 1402 of the workspace, a visualized wall will appear, alerting the user. Alternatively (or additionally), as the user approaches the wall, the boundary line's opacity may correlate with the user's distance to the boundary (e.g., becoming more opaque as the user gets closer).

In one embodiment, a passthrough cutout through VR walls may grow in size where the user's head or hands are nearest. As the user's head or hand is close enough to touch the wall, a cutout (i.e., see through window) is created. Through the cutout, user can see through the real-world environment.

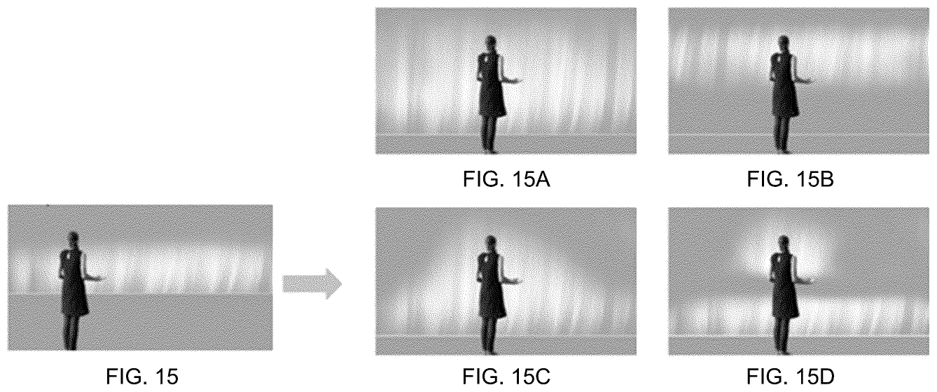

FIGS. 15 and 15A-15D depict possible variations of post-setup interactions 304 in VR in accordance with FIG. 3, relating to how boundary walls react to the proximity of the user. Taking one visualization as an example to demonstrate dynamic boundary wall behavior, FIG. 15 illustrates a boundary wall visualization when the user is at the furthest distance possible from the boundary wall, within the workspace. In FIG. 15, the visualization of the boundary wall includes effect highlights generally extending from below the user's eye level upward. In the variation of FIG. 15A, the visualization of the wall grows, extending from the floor to eye level and including a more-opaque bottom boundary, as the user gets closer to the boundary wall. In the variation of FIG. 15B, the effect highlights shift to user eye level and a more-opaque bottom boundary is rendered as the user gets closer. In the variation of FIG. 15C, the effect light grows/reacts by extending partially upward to the user's eye level in the region of proximity to the user's body. In the variation of FIG. 15D, the visualization effect includes new highlights at the user's eye level based on proximity to the user's body. These variations are merely exemplary, and other variations may be employed, as well as other visualizations of the boundary wall.

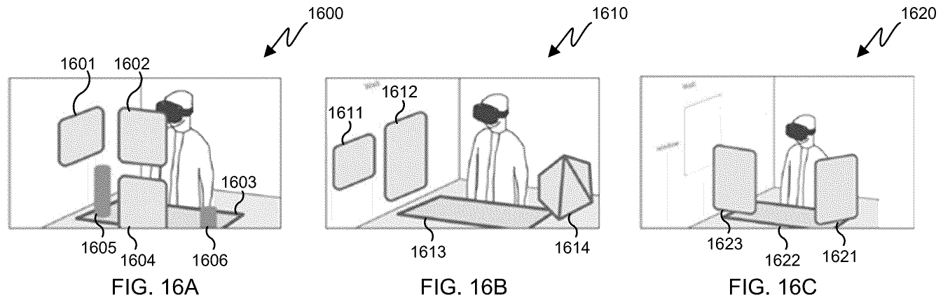

FIGS. 16A-16C depict possible variations of post-setup interactions 304 in AR/MR in accordance with FIG. 3, relating to layout based on the understood work regions. By having workspace setup in XR with surrounding surfaces understood by the system, a layout can be arranged automatically to save the user's time in arranging contents, boosting work productivity. In the layout 1600 depicted in FIG. 16A, the applications or contents 1601, 1602, 1603, and 1604 are smartly arranged considering obstacles 1605, 1606. Applications or contents with flatter presentation (e.g., for annotation or browsing) or potentially occupying a large 2D area will likely best be assigned on the wall side of the user. In the layout 1610 depicted in FIG. 16B, applications or contents are smartly arranged considering walls and open areas. For instance, applications or contents 1611, 1612, and 1613 with flatter presentation may be disposed on vertical and horizontal surfaces, while an application or content 1614 that is smaller or in a volumetric (3D) shape will likely best be assigned to the open side area of the work surface, so that the content does not block much of the user's view and the user has more room to interact with the 3D volumetric object. In the layout 1620 depicted in FIG. 16C, applications or contents are smartly arranged considering lighting. For instance, applications or contents 1621, 1622, and 1623 requiring a viewing experience may be assigned to regions in the workspace with better lighting, to protect the user's eyesight. These considerations (obstacles, walls/open areas, lighting) are merely exemplary of factors that may be taken into account in providing a smart layout for the workspace to the user. Other factors may also be considered. Of course, the user can modify the default layout presented as desired.

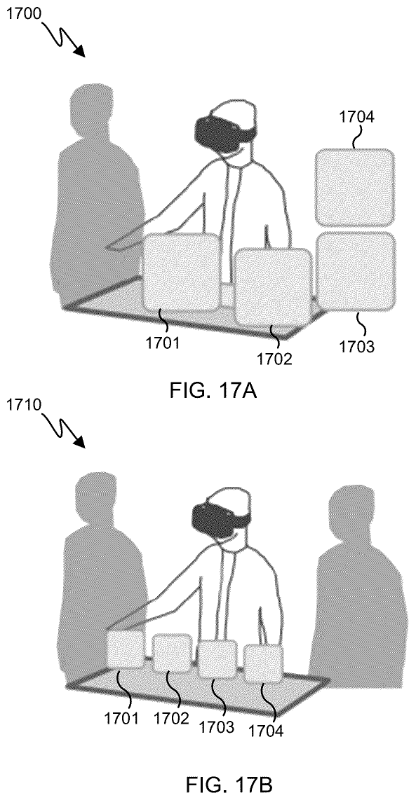

FIGS. 17A and 17B depict possible variations of post-setup interactions 304 in AR/MR in accordance with FIG. 3, relating to work arrangements based on user productivity. In the layout 1700 depicted in FIG. 17A, the default work arrangement is selected to be more efficient. Once the work surface is setup, contents for productivity in VR react and self-arrange according to scanned surroundings. For example, applications or contents 1701, 1702 such as main browsers, menus, or most recently opened application windows stay in the center of the user's field of view (FOV), while applications or contents 1703, 1704 for supplementary tools (e.g., widgets, menu, and quick notes) surround the user on the sides, making use of the user's full surrounding environment and desk surface. In the layout 1710 depicted in FIG. 17B, applications or contents 1701, 1702, 1703, and 1704 are displayed (as minimized and not actively being used, in the example depicted) and dynamically adjusted as the user or other people (represented by silhouettes) move around in the workspace. Computer vision keeps track, constantly updating the map of the user environment and the boundary for work area.

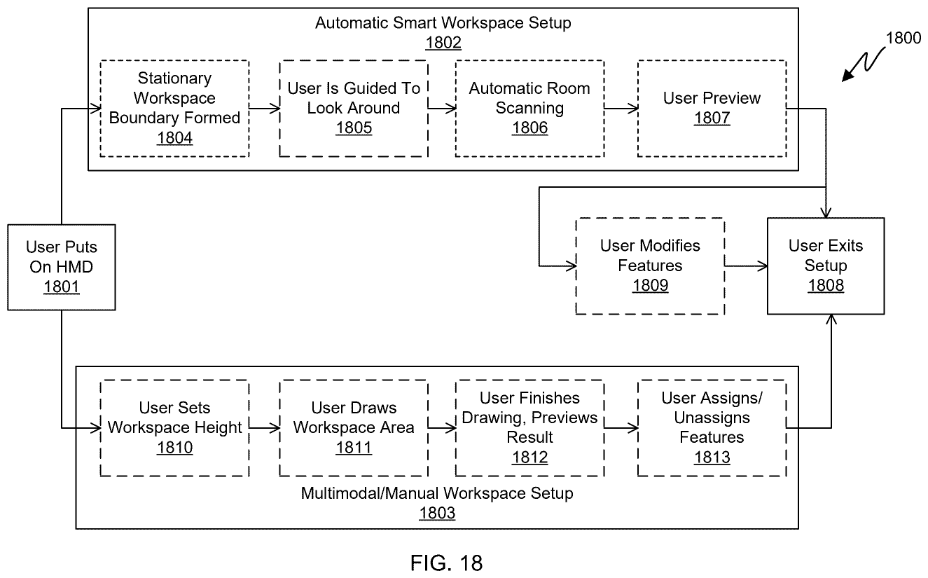

FIG. 18 is a diagram illustrating a UX system 1800 for multimodal workspace setup in accordance with this disclosure. For ease of explanation, the UX system 1800 of FIG. 18 is described as being implemented within the server 106 in the network configuration 100 of FIG. 1, and interacting with (for example) the electronic device 101 and/or the external electronic device 102 to set up an XR workspace for the electronic device 101. However, the UX system 1800 may be implemented using any other suitable device(s) and in any other suitable system(s). In FIG. 18, functions or operations outlined in solid lines or long dashes require user action or efforts, while functions or operations outlined in short dashes are automatic and do not require user effort.

The UX system 1800 in FIG. 18 begins operating when the user puts on the HMD 1801. The UX system 1800 proceeds either to automatic smart workspace setup 1802 or to multimodal/manual workspace setup 1803, depending upon the user's selection. Within automatic smart workspace setup 1802, the user sees that a stationary workspace boundary is formed 1804, and is guided to look around the workspace 1805. Automatic room scanning 1806 to determine objects on the workspace occurs as the user looks around, and a user preview 1807 is generated of the workspace, the obstacles, and work-related objects. From the user preview 1807, the user either exits desk setup 1808 with work-related objects, or the user modifies features 1809 such as portions of the scanned workspace area, the work-related objects and obstacles, and/or passthrough cutout areas before the user exits the workspace setup 1808. Within multimodal/manual workspace setup 1803, the user sets the preferred workspace height 1810 for a desk or table. The user draws the workspace space area 1811 using gaze and pinch. Upon the user finishing drawing and previewing the results 1812, the user may assign/unassign features 1813 such as portions of the scanned area, work-related objects and obstacles, or cutout areas before the user exits desk setup 1808.

Although FIG. 18 illustrates one example of a UX system 1800, various changes may be made to FIG. 18. For example, while shown as discrete functions operating serially, various functions in FIG. 18 could be combined or separated, or arranged to operate in a different order or to operate in parallel.

Referring back to FIG. 3, three entry points (“A,” “B,” and “C”) may be provided for the user to enter multimodal/manual workspace setup 1803, to setup the workspace and work surface(s) using gaze and hand gestures:
A. The user may modify the setup after the smart workspace setup 301 (smart workspace boundary setup 301, automatic scanning for smart workspace setup 302, and smart rendering and preview of the workspace setup 303).
B. If the system fails automatic scanning for smart workspace setup 302 and therefore generates a preview mesh of the area as described above, the user will have to manually setup the workspace area and work surface(s) as a fallback.
C. The user may wish to manually setup the workspace from the ground up.

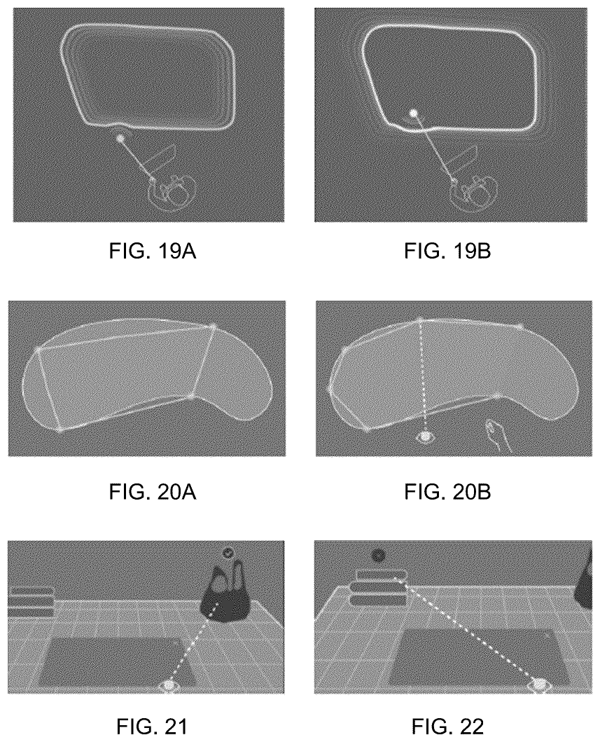

For scanned workspace modification with gaze and pinch, after the workspace area is scanned and rendered (entry point “A”) when the user modifies features 1809 in accordance with FIG. 18, the user can manually adjust the workspace using the following:
1. Enlarging or reducing the workspace area by pushing the cursor from the inside of the boundary to the outside to enlarge, or by pulling the boundary line inward from the outside to reduce, as illustrated (in greyscale) in FIGS. 19A and 19B, respectively. A reduction or enlarging action can be reflected with color change as a visual cue to the user (e.g., a change to a contrasting warm orange and yellow line, which radiates a slim warm ray inwards).
2. Adding editing points to redefine the shape, or adding more details to the complex shape, of a work surface as illustrated in FIGS. 20A and 20B, respectively.
3. Adding or removing obstacles outside of the area based on the system notification as illustrated in FIG. 21. Once the obstacle is removed, the system refreshes the mesh rendering.
4. Manually assigning or unassigning items as work-related objects in the workspace area as illustrated in FIG. 22. The system builds learning based on the historically assigned object preferences.
5. Refining the previewed passthrough cutout shapes.

Advanced modification interactions using gaze and pinch can include:

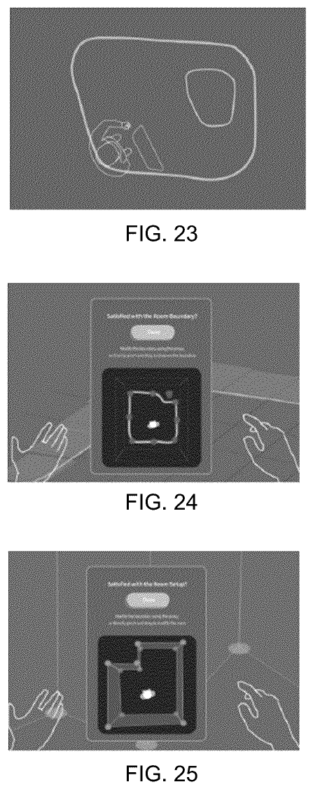

Subtracting area—When the user gazes inside the workspace area, then pinch-drags to circle an “island” inside the workspace boundary as illustrated in FIG. 23, for an area to be subtracted from the workspace area as a passthrough cutout, the circled “island” area turns into a cutout that can be seen through from VR environment.

Adding area—When the user gazes outside of the workspace area, then pinches and drags to a new area, the area will only be added if the newly drawn area is connected or overlapped to the original workspace area; otherwise, addition of the new area will not be successful.

Proxy manipulation—The user may optionally be provided with an interactive proxy (after the scan) presenting a preview 3D map as illustrated in FIG. 24, in which the user can adjust the boundary by using control points on the preview. A mini preview can aid the user in adjusting the wall positions during the workspace setup, as illustrated in FIG. 25.

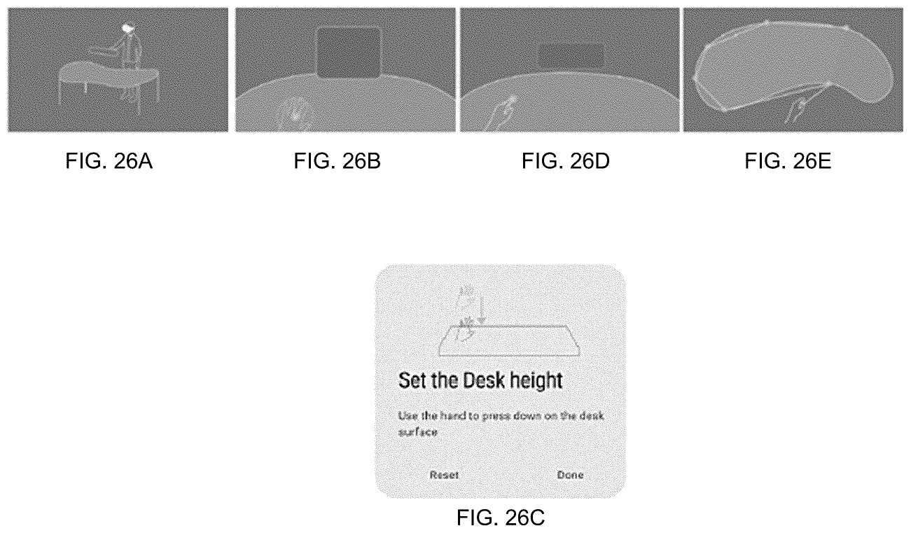

FIGS. 26A through 26E illustrate an example of manual desk setup using gaze and hand gestures (entry point “B”) as part of multimodal/manual workspace setup 1803 in accordance with FIG. 18. The user may initiate manual desk setup as illustrated in FIG. 26A, or the system may initiate manual desk setup due to failure of automatic scanning of the workspace area. A user interface (UI) prompt may be displayed as illustrated in FIG. 26B (an example UI prompt is shown in FIG. 26C) for the user to set table/desk height using a palm gesture by pressing down the user's palm on the physical surface. Upon confirming the table height, the user then gazes that a fingertip as shown in FIG. 26D. A visual effect confirms the action of manual setup of work surface area. The user gazes at each corner of the table and pinches to register the corner so that the work surface area shape is defined. (By contrast, in a traditional desk setup, only a square shape may be available, which is not ideal for a user who has an irregularly shaped work surface or who wants a more customized work surface area.) The user pinches on (or remotely indicates) the corners of the table to define the shape, as illustrated in FIG. 26E. The more points/corners that are registered, the more detail of the shape for the work surface area will be obtained. The area mesh continues to update based on registered corner points.

In defining work surface areas using gaze and hand gestures as part of multimodal/manual workspace setup 1803 in accordance with FIG. 18, there are many alternative ways for the user to define work surface area using gaze and hands:

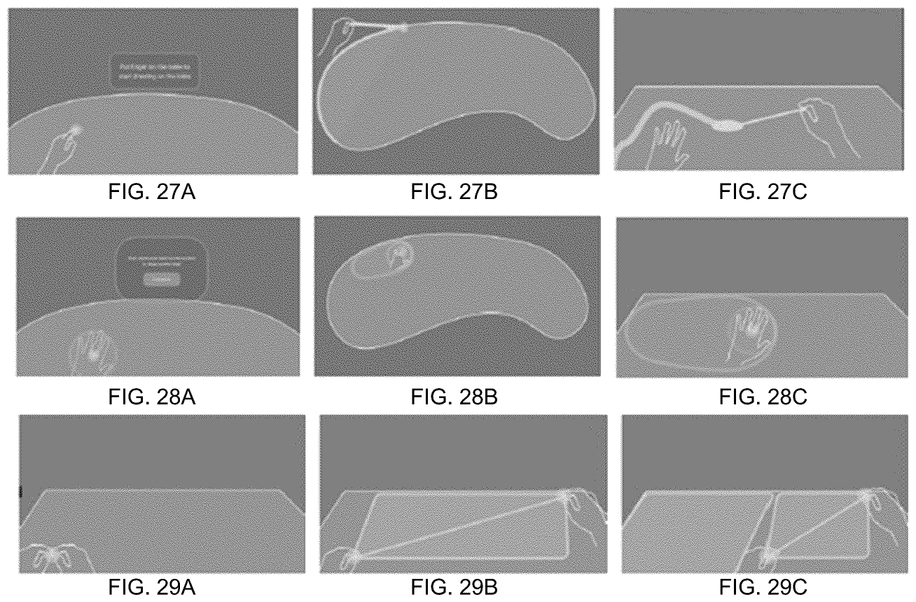

Remote tracing—After setting the work surface height, the user gazes at a point on the work surface (either on the edge or not) and pinch-drags out a line tracing the work surface shape as illustrated in FIGS. 27A through 27C. FIG. 27A illustrates a user gazing and touching at a starting point not located at an edge of the work surface. FIG. 27B illustrates a user tracing along an edge of a physical work surface. FIG. 27C illustrates a user defining an arbitrary portion of the physical surface as the work surface.

Palm swiping—After setting the desk height, the user gazes at the user's dominant palm for a few seconds as shown in FIG. 28A. A ring pops up over the palm as shown in FIG. 28B, indicating that the user's hand has becomes a brush. The user then swipes across the physical surface as shown in FIG. 28C, to define the work surface shape.

Diagonal mapping—After setting the desk height, the user gazes at the cross point of where the user's two-hand pinch gesture is located as shown in FIG. 29A. Then user drag and pulls hands in diagonal line as shown in FIG. 29B, to define the work surface shape. The diagonal line defines a rectangular shape that the user can map to the work surface area.

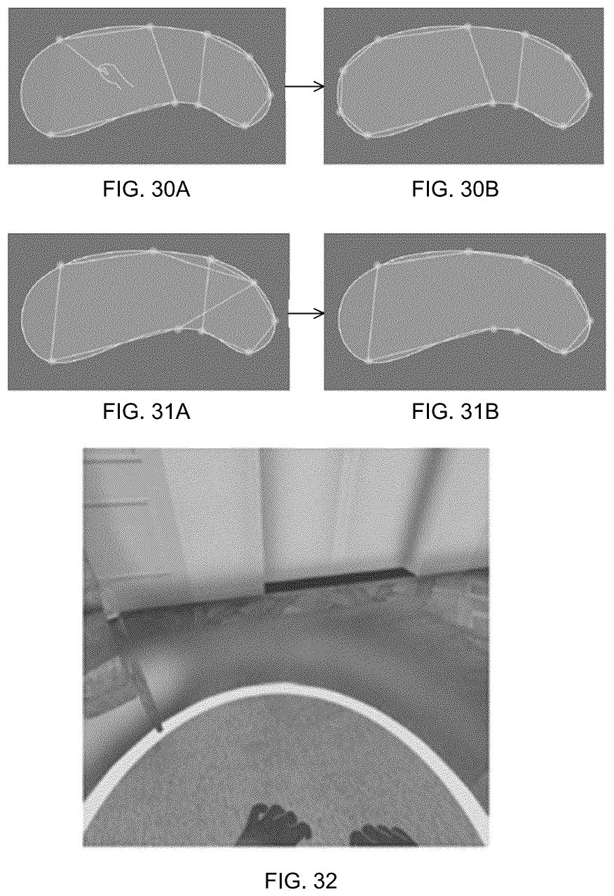

In defining multiple work surface areas using gaze and hand gestures as part of multimodal/manual workspace setup 1803 in accordance with FIG. 18, multiple work surface areas can be created on a physical surface by the user gazing and pinching on a new area after defining a first work surface area, as shown for the diagonal mapping approach in FIG. 29C and for remote tracing in FIGS. 30A and 30B (in which a first work surface area is first defined on the left side of the physical surface, and then a second work surface area is then defined on the right side). The defined work surface areas are placeable for virtual tools and general dynamical occlusion, for blending virtual objects to physical environment.

Work surface areas can also be manipulated after being defined. Work surface areas defined as separated by intervening space (as illustrated in FIGS. 30A and 30B) remain separated if the two area are not connected or overlapped. Multiple workspace areas are possible, enabling more complex total workspace area tailored to the user's needs. On the other hand, if two work surface areas are defined as overlapped, the two areas will be merged as illustrated by FIGS. 31A and 31B.

This present disclosure also relates to various UX-oriented visualization effects that help to support smart workspace boundary setup, so users can have a more enjoyable and user-friendly setup process. The types of visualization effects include:
2 stationary workspace boundary visualizations;
6+ automatic scanning visualizations;
11+ obstacle rendering visualizations;
6+ modification visualizations; and
7+ post setup boundary wall visualizations.

The principles for rendering visual effects include:
Environmental blending during setup: Contrast enough to be noticeable, but also blending well into the environment.
User safety: Keep certain degree of transparency, to not block the user's view or hide any obstacles.
Aesthetically pleasant: Subtle and smooth so as not to intimidate the user, cause motion sickness, or induce a sense of constraint.
Performant: Procedurally rendered without slowing down the system.
Instructive: Treatment is instructive and actionable, so the user knows how to react. For this, an additional UI animation or prompt can be provided.
User safety: Apply transparency based upon UX needs so as not to impede the user's view.
Simplicity: Any warning message from the visualization is universally understood and delivered.
Informs distance: While in VR, the varied form and colors of the visual effect lights create a form that has a distinguishable width which provides spatial information.
Unique: Animated color effects are preferably unique and not replicated in most VR environments.

FIG. 32 illustrates rendering of a stationary workspace boundary during smart rendering and preview of the workspace setup 303 in accordance with FIG. 3. A stationary workspace boundary is virtual boundary of a safe work area. By default, the system automatically creates a circular boundary around the user in the work region. There are several visualization effects may be employed. In general, the user sees “light rays” emanating from the boundary line, as shown in FIG. 32. The effect can be smoky, vapory, or involve light waves. Color varies based on preference or based on the understanding of the tone of environment, to create enough contrast. The visual effect can be applied while the stationary boundary is forming, directing the user's attention for the forming process. Alternatively, the effect can be applied at the end of the workspace setup process as a one-time completion effect, to inform the user that the process is completed.

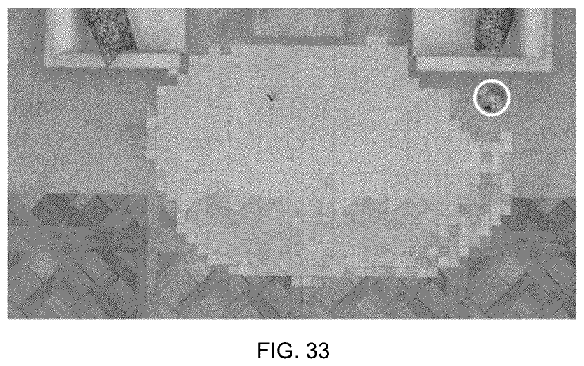

FIG. 33 illustrates rendering during smart rendering and preview of the workspace setup 303 in accordance with FIG. 3. The visualization effect during rendering for automatic scanning includes two parts: actively scanning the area; and settled scanned area. FIG. 33 is an example of the visualization effect for automatic scanning, where the actively scanned area is covered by flipping/blinking pixelated mesh that symbolizes the real workspace is being digitalized and the AR/MR work environment is ready. The mesh animates the newly scanned area, which eventually settles, marking a confirmed scanned area. As scanning progresses, the newly scanned area appears more transparent and gradually becomes as translucent as already scanned areas. In variations of scanning rendering: the mesh tile can be in shapes other than squares (e.g., triangular, irregular, hexagonal, etc.); each tile/mesh unit can vary in sizes and animation speed; and colors and transparency can be customized based on the user's need (e.g., the user can set the color in the settings). In addition to pixelation with different amination speeds, pixelation in different colors, and pixelation with different degrees of transparency, other variations include pixelation with wider/narrower negative spaces (between pixels), dotted pixelation (having little negative space), and pixelation with wider/thinner offsets. The visual effects for pixelation may be rendered as particle dots (i.e., a point cloud), a coloring gradient, a combination of coloring and dots, or as chromatic glass tiles.

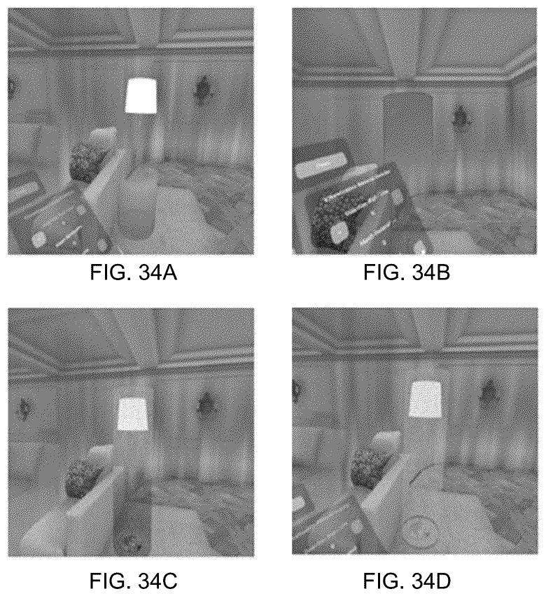

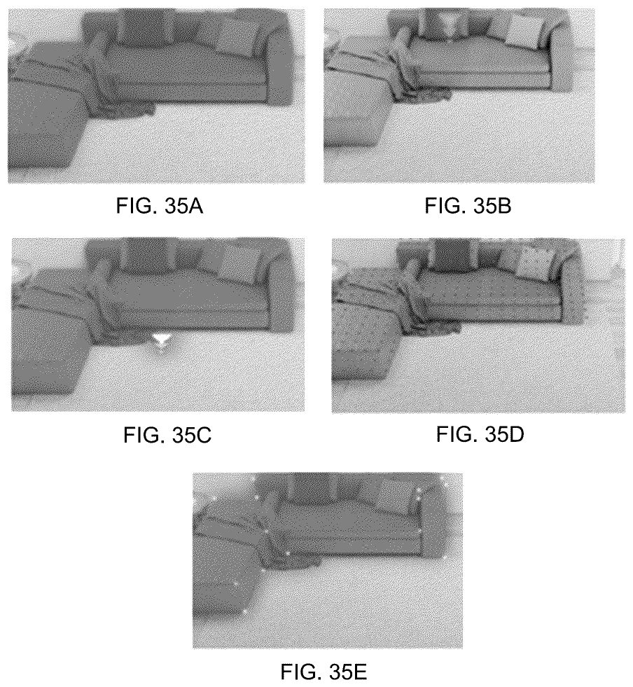

FIGS. 34A through 34D and FIGS. 35A through 35E illustrate rendering for obstacle warnings during smart rendering and preview of the workspace setup 303 in accordance with FIG. 3. Upon completion of scanning, unrecognized items on the work surface or items that have been labeled as not work-related are treated as obstacles in the workspace area, with a warning visualization applied to inform user remove the item and keep the work surface area clean. More generally, the visualization effects for marking workspace area obstacles upon completion of scanning includes two parts: providing volume and depth information about each obstacle; and optionally providing information for how to treat the respective obstacle (e.g., hide, clean up/remove, etc.).

Within the workspace in general, visualization effects are applied obstacles to user movement through the physical space corresponding to the workspace. In the case of FIGS. 34A through 34D, a lamp limits user movement, and visualization effects are applied. In the example of FIG. 34A, the visualization effects are a gradient sheath extending from the base of the object upward with the rational that, given the shape of the obstacle, collision is most likely between the user's feet and the obstacle's base. In FIG. 34B, the gradient sheath extends from the top of the obstacle downward, to warn of possible collision with the user's head. The gradient is in transparency of the visualization effect, which diminishes from opaque to fully transparent with distance in the examples of FIGS. 34A and 34B. In the example of FIG. 34C, the transparency gradient may depend on the distance of an outer surface of the obstacle from the user. As shown in FIG. 34D, the transparency may be consistent along the entirety of the sheath. Both FIGS. 34C and 34D illustrate an opaque warning indicator (a ring in the examples depicted) around the base of the obstacle.

Variations of obstacle rendering, such as color, texture, and/or pattern of the visualization effect, can be based on the user's preference, or the colors may be automatically selected by the system based on the average tone of the workspace environment. For example, where the workspace environment is determined to have cool tone, the warning color may be set to be warm tone, and vice versa. The height of the gradient light ray sheath may vary based on the object height. The texture, color, and the direction of the projection for the sheath may also be customizable in the settings, as long as the settings provide enough depth and volume information about the obstacles to the user.

Other potential obstacle visualization effects include: flashing coloring, a universal warning language, may be used as a signal to catch the user's attention, illustrated by (but not visible in the still image of) FIG. 35A; a bold, animated UI, pointing the user to where attention should be paid during user movement as illustrated by FIG. 35B; a combination of visualization effects, mixed to achieve UX purposes, as illustrated by FIG. 35C; a point-cloud mesh indicating the approximate shape of the obstacle as illustrated by FIG. 35D, where the mesh can cover the entire obstacle or only the portion of the obstacle that is inside the workspace boundary; and/or a bounding box as illustrated by FIG. 35E, where a simplified point-cloud mesh with shades may be used to form the bounding box around the obstacle.

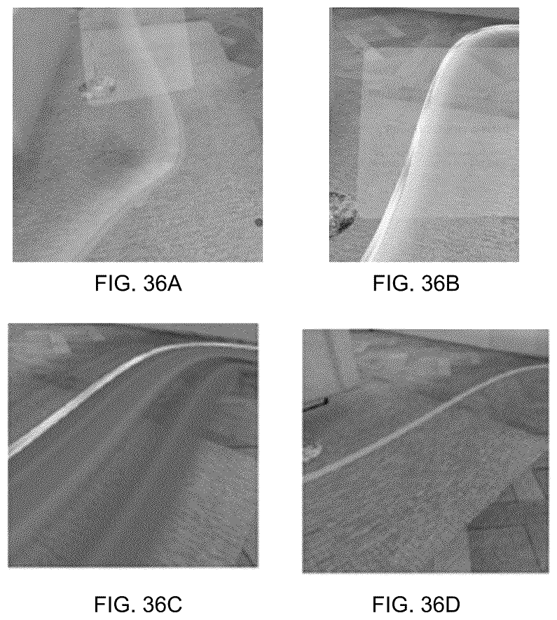

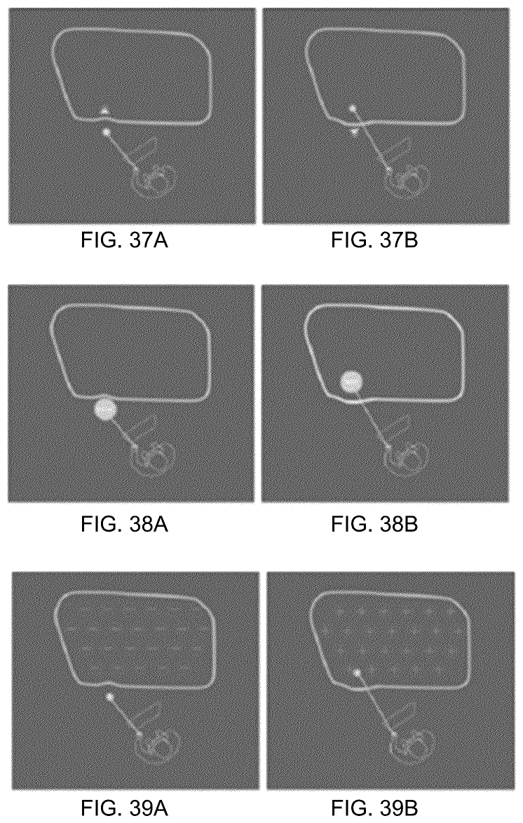

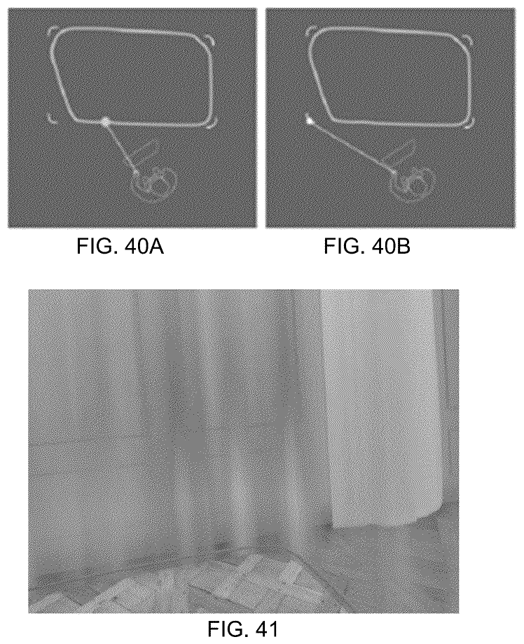

FIGS. 36A through 36D illustrate rendering for boundary modification during post-setup interactions 304 in accordance with FIG. 3. Typical visualization effects for boundary modification may include two parts: a boundary line enclosing the workspace area; and a guiding UI for instructing the user on how to extend or retract the boundary. FIGS. 36A and 36B illustrate use of a subtle wavy UI to animate the directions in which the user can extend or retract the boundary, by pulling or pushing to modify. Variations of rendering for boundary modification can include varying the wave thickness as shown in FIG. 36C, the wave color(s), and/or the wave's patterned textures as shown in FIG. 36D, so that the user can have several modification visualization effects. FIGS. 37A-37B, FIGS. 38A-38B, FIGS. 39A-39B, and FIGS. 40A-40B illustrate a few other examples of visualization effects for boundary modification: FIGS. 37A-37B illustrate UI directional arrows straightforwardly indicating how user should move the cursor; FIGS. 38A-38B illustrate a UI where text appears on the cursor; FIGS. 39A-39B illustrate symbolic approach where − or + symbol patterns are applied, which can be universally understood by any language speakers; and FIGS. 40A-40B illustrate scaling handler appearing on hover, familiar to many electronic device users.

FIG. 41 illustrates rendering for post-setup wall effects during post-setup interactions 304 in accordance with FIG. 3. The visualization for marking workspace area upon completion includes two parts: a boundary highlighting the take-up area; and an optional boundary wall enhancing the user's sense of depth in the workspace, alerting the user to distance from the boundary and physical walls. To avoid having the user feeling constrained or “cage-y,” the wall animation emanates from the floor and rises as shown in FIG. 41, and moves slightly to look softer and create a sense of breathing. Variations of wall rendering include: the wall rendering shader is extendable in many ways, allowing for a lot of visual effects, such as the height and color being variable based on user needs and the automatically scanned results, or colors and transparency can be customized based on the user's need. The user can set the color in the settings. Additional variations on wall rendering include: by varying light ray directions from vertical to horizontal, or increasing the wavy effects, more visual effect can be produced; and/or other visualization effects include fluid lines, and tinted glass in different patterns/tiles. Variations may be made in light color variation, use of light columns, emulating ocean waves, projecting digital fabric, rendering as textured glass, or rendering as fluid lines.

Referring back to FIG. 4, as depicted there are four potential workspace setup entry point options for triggering workspace setup:
1. Workspace setup is initiated automatically when at least one usable surface is detected by the automatic room scanning during boundary setup.
2. User sets up workspace after the boundary setup by prompt.
3. User manually setting up workspace boundary in the boundary setup process.
4. User enabling workspace setup separately in the settings.

Scenarios where the user has a need that may trigger workplace boundary setup:

| A. Enter a new area | | C. Back to the |
|---|---|---|
| for VR | B. Manual Setup | same area |
| 1. Out of box experience | 1. User wants to | No action required: |
| (OOBE) (for first VR | modify the existing | |
| experience) | boundary line | |
| 2. User back to VR in a | 2. User wants to | 1. User is back to VR |
| new location | redraw the boundary | experience in the |
| | line | same location |
| 3. Users hands over the | | 2. User is back to the |
| HMD to another | | original guardian |
| outside the boundary | | with different |
| | | location in the |
| | | guardian |
| 4. User launches an | | |
| immersive app in | | |
| passthrough in a new | | |
| location | | |
| 5. User uses universal | | User action required: |
| menu to turn off | | |
| passthrough and enter VR | | |
| 6. User switches from | | 1. User is back to VR |
| passthrough to VR | | in the same location |
| environment through | | but with new |
| physical user interface | | obstacles in view |
| (PUI) without guardian | | |
| setup or in a new | | |
| location | | |
| 7. USER is back to VR in | | |
| the same area, but the | | |
| system does not | | |
| recognize the place | | |

Below is a list of example use cases and user needs for workspace setup:
1. I want to start working right away without any confusion of setting up the space.
2. I don't want to spend too much time on organizing each time I change position or posture.
3. I want to have a clean work environment.
4. I want to have a customized workspace.
5. I want to easily interact with work items between virtual and real world.
6. I want to work immersively without distractions.
7. I want to easily get access to all my work device.
8. I want to feel comfortable and smart in my workspace, and without feeling constrained.
9. I want cooler XR working experience.
10. I want to stay informed about my space.

Post Setup Scenario: Layout Based on the Understood Work Regions

Consider an example in which a user is practicing a presentation in an XR environment, with (physically) a notebook, a vase, and a pen on the desk, and virtual note sticky notes, a 3D model prototype, and a presentation deck in XR. If a usable wall is detected on one side of user and an open area is detected on the other side, the system may recognize a logical layout as follows:
1. A flatter presentation deck and virtual browser are floating right in front of the user's FOV. Virtual sticky notes lay on the side wall as supplementary materials. The vase on the desk is encased in a warning color as a potentially dangerous obstacle.
2. A 3D model prototype is automatically placed at the side of the table that is furthest away from the walls, so the user has more space for interaction.
3. Panels adjust screen brightness based on real-environment lighting, or vice versa, with virtual lighting adjusted brighter where the physical notebooks and pen are located.

### Post Setup Scenario: Dynamic Workspace Arrangement

While workspace is scanned and understood, a workspace layout used for versatile settings can be achieved. For example, if the user allows social mode during work (or even simply turns off do-not-disturb), the system may dynamically update the virtual contents every time others enter the user's workspace. The user can conveniently interact with people without rearranging the workspace contents every time to make space for the people.

When there is another person (e.g., barista) entering the workspace boundary for the user, the boundary may light up to notify the user and the digital content may automatically move for the “guest.”

Additional use cases for the workspace setup described above include:

Dynamic sound space—Workspace setup can also be a source for spatial audio in XR environment. When in the workspace region, the user hears more quiet, soothing sounds, music, or white noise for a better productivity. In a do-not-disturb mode, noises around users are reduced. When social mode is on, the user can gradually hear others' conversations the others approach the user.

Keep tidy—Additional, the system can hide objects (e.g., cables) that are visually messy, so that the user has a relatively cleaner XR workspace than the real one.

Easy finding—There is also the possibility that work-related objects are scanned and recognized during setup, the user can easily locate items with the system providing visual cues. For example, if the user has lots of registered work items which are placed loosely and randomly on the table, the user may forget where an object (e.g., a USB device) was left. The user may use a voice query which then uses UI animation to point the user to the object. Even if the system is unable to find the object, the system can be helpful by letting the user to know that the object is not in the workspace region.

The various contents of FIG. 3 through FIG. 41 described above are for illustration and explanation only, and the figures do not limit the scope of this disclosure to the illustrated or described details.

It should be noted that the functions shown in the figures or described above can be implemented in an electronic device 101, 102, 104, server 106, or other device(s) in any suitable manner. For example, in some embodiments, at least some of the functions shown in the figures or described above can be implemented or supported using one or more software applications or other software instructions that are executed by the processor 120 of the electronic device 101, 102, 104, server 106, or other device(s). In other embodiments, at least some of the functions shown in the figures or described above can be implemented or supported using dedicated hardware components. In general, the functions shown in the figures or described above can be performed using any suitable hardware or any suitable combination of hardware and software/firmware instructions. Also, the functions shown in the figures or described above can be performed by a single device or by multiple devices.

Although this disclosure has been described with reference to various example embodiments, various changes and modifications may be suggested to one skilled in the art. It is intended that this disclosure encompass such changes and modifications as fall within the scope of the appended claims.

What is claimed is:

1. A method of a smart workspace setup in an extended reality (XR) environment, the method comprising:
detecting that a user is wearing an XR headset including a display and one or more sensors with world sensing capabilities;
automatically scanning, using the one or more sensors, an environment of the XR headset to identify boundaries of a workspace within the environment, at least one work surface within the workspace, and any obstacles within the workspace;
displaying, using three-dimensional (3D) user interface (UI) visualizations on the display of the XR headset, a virtual boundary of the workspace, a representation of the at least one work surface, and indicators for identified obstacles within the workspace; and
displaying UI elements on the display of the XR headset for visualizations for user modification of one or more of the virtual boundary, the representation of the at least one work surface, or the indicators for the identified obstacles, wherein the UI elements for the visualizations for user modification include guides for completing setup through user modification.

2. The method of claim 1, wherein the virtual boundary is rendered as a semi-transparent virtual wall with animated color effects.

3. The method of claim 1, wherein displaying UI elements of the visualizations for user modification of one or more of the virtual boundary, the representation of the work surface, or the indicators for the identified obstacles further comprises at least one of:
rendering a virtual mesh corresponding to the workspace on the display of the XR headset;
displaying, on the display of the XR headset, a preview of at least one pass-through cutout area for computing peripheral devices within the representation of the work surface;
displaying each obstacle with visual effects covering a volume or area where the respective obstacle is positioned within the workspace; or
enabling user modification of the workspace by one of extending the representation of the at least one work surface, adding to the representation of the at least one work surface, reducing the representation of the at least one work surface, subtracting from the representation of the at least on work surface, or combining two representations of work surfaces among the at least one work surface.

4. The method of claim 3, wherein displaying each obstacle with visual effects covering the volume or area where the respective obstacle is positioned within the workspace further comprises:
displaying a light column covering the volume or area where the respective obstacle is positioned within the workspace, wherein a bottom portion of the light column is substantially opaque.

5. The method of claim 1, wherein automatically scanning the environment of the XR headset further comprises recognizing horizontal or vertical surfaces in a mixed reality (MR) environment corresponding to the XR environment that satisfy criteria defined for work surfaces.

6. The method of claim 1, wherein automatically scanning the environment of the XR headset further comprises providing visual guidance on the display of the XR headset for user movement to facilitate the scanning.

7. The method of claim 1, wherein automatically scanning the environment of the XR headset further comprises recognizing work-related objects and obstacles on the at least one work surface.

8. An electronic device for smart workspace setup in an extended reality (XR) environment, the electronic device comprising:
at least one processing device configured to:
detect that a user is wearing an XR headset including a display and one or more sensors with world sensing capabilities;
automatically scan, using the one or more sensors, an environment of the XR headset to identify boundaries of a workspace within the environment, at least one work surface within the workspace, and any obstacles within the workspace;
display, using three-dimensional (3D) user interface (UI) visualizations on the display of the XR headset, a virtual boundary of the workspace, a representation of the at least one work surface, and indicators for identified obstacles within the workspace; and
display UI elements on the display of the XR headset for visualizations for user modification of one or more of the virtual boundary, the representation of the at least one work surface, or the indicators for the identified obstacles, wherein the UI elements for the visualizations for user modification include guides for completing setup through user modification.

9. The electronic device of claim 8, wherein the virtual boundary is rendered as a semi-transparent virtual wall with animated color effects.

10. The electronic device of claim 8, wherein the at least one processing device configured to display UI elements of the visualizations for user modification of one or more of the virtual boundary, the representation of the work surface, or the indicators for the identified obstacles by at least one of:
rendering a virtual mesh corresponding to the workspace on the display of the XR headset;
displaying, on the display of the XR headset, a preview of at least one pass-through cutout area for computing peripheral devices within the representation of the work surface;
displaying each obstacle with visual effects covering a volume or area where the respective obstacle is positioned within the workspace; and
enabling user modification of the workspace by one of extending the representation of the at least one work surface, adding to the representation of the at least one work surface, reducing the representation of the at least one work surface, subtracting from the representation of the at least on work surface, or combining two representations of work surfaces among the at least one work surface.

11. The electronic device of claim 10, wherein the at least one processing device configured to display each obstacle with visual effects covering the volume or area where the respective obstacle is positioned within the workspace by:
displaying a light column covering the volume or area where the respective obstacle is positioned within the workspace, wherein a bottom portion of the light column is substantially opaque.

12. The electronic device of claim 8, wherein automatically scanning the environment of the XR headset further comprises recognizing horizontal or vertical surfaces in a mixed reality (MR) environment corresponding to the XR environment that satisfy criteria defined for work surfaces.

13. The electronic device of claim 8, wherein automatically scanning the environment of the XR headset further comprises providing visual guidance on the display of the XR headset for user movement to facilitate the scanning.

14. The electronic device of claim 8, wherein automatically scanning the environment of the XR headset further comprises recognizing work-related objects and obstacles on the at least one work surface.

15. A non-transitory machine readable medium for smart workspace setup in an extended reality (XR) environment, the non-transitory machine readable medium comprising instructions that when executed cause at least one processing device of an electronic device to:
detect that a user is wearing an XR headset including a display and one or more sensors with world sensing capabilities;
automatically scan, using the one or more sensors, an environment of the XR headset to identify boundaries of a workspace within the environment, at least one work surface within the workspace, and any obstacles within the workspace;
display, using three-dimensional (3D) user interface (UI) visualizations on the display of the XR headset, a virtual boundary of the workspace, a representation of the at least one work surface, and indicators for identified obstacles within the workspace; and
display UI elements on the display of the XR headset for visualizations for user modification of one or more of the virtual boundary, the representation of the at least one work surface, or the indicators for the identified obstacles, wherein the UI elements for the visualizations for user modification include guides for completing setup through user modification.

16. The non-transitory machine readable medium of claim 15, wherein the virtual boundary is rendered as a semi-transparent virtual wall with animated color effects.

17. The non-transitory machine readable medium of claim 15, wherein the instructions when executed cause the at least one processing device to display UI elements of the visualizations for user modification of one or more of the virtual boundary, the representation of the work surface, or the indicators for the identified obstacles by at least one of:
rendering a virtual mesh corresponding to the workspace on the display of the XR headset;
displaying, on the display of the XR headset, a preview of at least one pass-through cutout area for computing peripheral devices within the representation of the work surface;
displaying each obstacle with visual effects covering a volume or area where the respective obstacle is positioned within the workspace; and
enabling user modification of the workspace by one of extending the representation of the at least one work surface, adding to the representation of the at least one work surface, reducing the representation of the at least one work surface, subtracting from the representation of the at least on work surface, or combining two representations of work surfaces among the at least one work surface.

18. The non-transitory machine readable medium of claim 17, wherein the instructions when executed cause the at least one processing device to display each obstacle with visual effects covering the volume or area where the respective obstacle is positioned within the workspace by:
displaying a light column covering the volume or area where the respective obstacle is positioned within the workspace, wherein a bottom portion of the light column is substantially opaque.

19. The non-transitory machine readable medium of claim 15, wherein automatically scanning the environment of the XR headset further comprises recognizing horizontal or vertical surfaces in a mixed reality (MR) environment corresponding to the XR environment that satisfy criteria defined for work surfaces.

20. The non-transitory machine readable medium of claim 15, wherein automatically scanning the environment of the XR headset further comprises providing visual guidance on the display of the XR headset for user movement to facilitate the scanning.
